(19) United States
(12) Patent Application Publication
(10) Pub. No.: US 2024/0049307 A1
(43) Pub. Date: Feb. 8, 2024

(54) METHOD AND APPARATUS FOR RANDOM ACCESS RESOURCE MAPPING IN NON-TERRESTRIAL NETWORK

(71) Applicant: Telefonaktiebolaget LM Ericsson (publ), Stockholm (SE)

(72) Inventors: Zhipeng LIN, Jiangsu (CN); Xingqin LIN, Santa Clara, CA (US); Jonas SEDIN, Sollentuna (SE)

(21) Appl. No.: 18/257,488

(22) PCT Filed: Dec. 20, 2021
(86) PCT No.: PCT/SE2021/051293

§ 371 Date: Jun. 14, 2023

(30) Foreign Application Priority Data
Dec. 23, 2020 (WO) PCT/CN2020/138685

(51) Int. Cl. H04W 74/08; H04B 7/185

(52) U.S. Cl. CPC H04W 74/0891; H04W 74/0833; H04B 7/18532; H04W 84/06

(57) ABSTRACT

Various embodiments of the present disclosure provide methods and apparatuses for random access resource mapping in a non-terrestrial network (NTN). According to an embodiment, the method implemented at a network node in the NTN includes determining at least a first synchronization signal (SS)/physical broadcast channel (PBCH) block, SSB, group having one or more SSBs and a second SSB group having one or more SSBs; mapping a respective number of random access resources to the one or more SSBs in the first SSB group and the one or more SSBs in the second SSB group separately; and transmitting configuration information indicating the mapping of the respective number of random access resources to the one or more SSBs in the first SSB group and the one or more SSBs in the second SSB group.

### FIELD OF THE INVENTION

The present disclosure generally relates to wireless communications, and more specifically, to methods and apparatuses for random access resource mapping in a non-terrestrial network (NTN).

### BACKGROUND

This section introduces aspects that may facilitate a better understanding of the disclosure. Accordingly, the statements of this section are to be read in this light and are not to be understood as admissions about what is in the prior art or what is not in the prior art.

In 3GPP Release 8, Evolved Packet System (EPS) was specified. EPS is based on a Long-Term Evolution (LTE) radio network and Evolved Packet Core (EPC). It was originally intended to provide voice and mobile broadband (MBB) services but has continuously evolved to broaden its functionality. Since 3GPP Release 13, narrowband Internet of things (NB-IoT) and LTE-Machine to Machine (LTE-M) are part of the LTE specifications and provide connectivity to massive machine type communications (mMTC) services.

In 3GPP Release 15, the first release of 5G system (5GS) was specified. This is a new generation's radio access technology intended to serve use cases such as enhanced mobile broadband (eMBB), ultra-reliable and low latency communication (URLLC) and mMTC. 5G includes New Radio (NR) access stratum interface and 5G Core Network (5GC). The NR physical and higher layers are reusing parts of the LTE specifications, and add needed components when motivated by new use cases. One such component is a sophisticated framework for beam forming and beam management to extend the support of the 3GPP technologies to a frequency range going beyond 6 GHz.

In 3GPP Release 15, 3GPP started the work to prepare NR for operation in a Non-Terrestrial Network (NTN). The work was performed within the study item “NR to support Non-Terrestrial Networks” and resulted in TR 38.811 v15.4.0. In 3GPP Release 16, the work to prepare NR for operation in an NTN network continued with the study item “Solutions for NR to support Non-Terrestrial Network”. In parallel the interest to adapt NB-IoT and LTE-M for operation in NTN is growing. As a consequence, 3GPP Release 17 contains both a work item on NR NTN and a study item on NB-IoT and LTE-M support for NTN.

Accordingly, random access procedures need to be improved in NR for NTN and NB-IoT and LTE-M for NTN.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure proposes a solution of flexible random access resource mapping in the NTN. In the solution, the random access resources can be allocated in a more dynamic way to a plurality of synchronization signal (SS)/physical broadcast channel (PBCH) blocks (SSBs).

According to a first aspect of the present disclosure, there is provided a method implemented at a network node in a non-terrestrial network (NTN). The method comprises determining at least a first synchronization signal (SS)/physical broadcast channel (PBCH) block (SSB) group comprising one or more SSBs and a second SSB group comprising one or more SSBs, mapping a respective number of random access resources to the one or more SSBs in the first SSB group and the one or more SSBs in the second SSB group separately, and transmitting configuration information indicating the mapping of the respective number of random access resources to the one or more SSBs in the first SSB group and the one or more SSBs in the second SSB group.

In accordance with an exemplary embodiment, the mapping a respective number of random access resources to the one or more SSBs in the first SSB group and the one or more SSBs in the second SSB group separately may comprise allocating a first number of preambles to each SSB of the first SSB group, and allocating a second number of preambles to each SSB of the second SSB group.

In accordance with an exemplary embodiment, the first number and the second number may be different.

In accordance with an exemplary embodiment, the mapping a respective number of random access resources to the one or more SSBs in the first SSB group and the one or more SSBs in the second SSB group separately may comprise mapping a first set of RACH occasions to the one or more SSBs in the first SSB group, and mapping a second set of RACH occasions to the one or more SSBs in the second SSB group.

In accordance with an exemplary embodiment, the number of RACH occasions in the first set may be different from the number of RACH occasions in the second set.

In accordance with an exemplary embodiment, the mapping of a respective number of random access resources to the one or more SSBs in the first SSB group and the one or more SSBs in the second SSB group separately may comprise configuring a first SSB to random access channel, RACH, occasion mapping for the first SSB group, and configuring a second SSB to RACH occasion mapping for the second SSB group.

In accordance with an exemplary embodiment, the first and second numbers of preambles and/or the number of RACH occasions in the first and second set may be different depending on at least one of sizes of beams for which the first SSB group and the second SSB group are used and/or a beam deployment in a coverage of the network node.

In accordance with an exemplary embodiment, the method may further comprise configuring a dedicated SSB resource list for one of the first and second SSB groups for a contention-free random access procedure, wherein the SSB resource in the dedicated SSB resource list indicates one or more SSB indices and one or more preamble identifiers. The configuration information may further indicate the dedicated SSB resource list.

In accordance with an exemplary embodiment, the method may further comprise configuring a dedicated SSB to RACH occasion mapping for one of the first and second SSB groups for a contention-free random access procedure. The configuration information may further indicate the dedicated SSB to RACH occasion mapping.

In accordance with an exemplary embodiment, the method may further comprise determining, for a two-step random access procedure, a first mapping ratio between a Physical Random Access Channel, PRACH, resource and a Physical Uplink Shared Channel, PUSCH, resource for the first SSB group, and determining a second mapping ratio between the PRACH resource and the PUSCH resource for the second SSB group. The configuration information may further indicate the first mapping ratio and the second mapping ratio.

In accordance with an exemplary embodiment, the first mapping ratio may be different from the second mapping ratio.

In accordance with an exemplary embodiment, the first SSB group may be used for wide beams, and the second SSB group may be used for narrow beams.

In accordance with an exemplary embodiment, when the wide beam is used to cover an area that has a larger amount of expected terminal devices than the narrow beam, at least one of the followings:
1) the first number of preambles is larger than the second number of preambles;
2) the number of RACH occasions in the first set is larger than the number of RACH occasions in the second set; and
3) the first mapping ratio is larger than the second mapping ratio.

In accordance with an exemplary embodiment, when the wide beam is used to cover an area that has a smaller amount of expected terminal devices than the narrow beam, at least one of the followings:
1) the first number of preambles is smaller than the second number of preambles;
2) the number of RACH occasions in the first set is smaller than the number of RACH occasions in the second set; and
3) the first mapping ratio is smaller than the second mapping ratio.

In accordance with an exemplary embodiment, the method may further comprise receiving a preamble on a RACH occasion from a terminal device, and determining the SSB that was used by the terminal device, based on the received preamble and the RACH occasion.

According to a second aspect of the present disclosure, there is provided a method implemented at a terminal device in an NTN. The method comprises receiving configuration information indicating a mapping of a respective number of random access resources to one or more SSBs in a first SSB group and one or more SSBs in a second SSB group, selecting the SSB of the first SSB group or the second SSB group, and performing a random access procedure using the random access resource mapped to the selected SSB.

In accordance with an exemplary embodiment, the mapping may comprise a first number of preambles being allocated to each SSB of the first SSB group, and a second number of preambles being allocated to each SSB of the second SSB group.

In accordance with an exemplary embodiment, the mapping may comprise a first set of RACH occasions being mapped to the one or more SSBs in the first SSB group, and a second set of RACH occasions being mapped to the one or more SSBs in the second SSB group.

In accordance with an exemplary embodiment, the mapping may comprise a first SSB to random access channel, RACH, occasion mapping being configured for the first SSB group, and a second SSB to RACH occasion mapping being configured for the second SSB group.

In accordance with an exemplary embodiment, the configuration information may further indicate a dedicated SSB resource list for one of the first and second SSB groups for a contention-free random access procedure, wherein the SSB resource in the dedicated SSB resource list indicates one or more SSB indices and one or more preamble identifiers.

In accordance with an exemplary embodiment, the configuration information may further indicate a dedicated SSB to RACH occasion mapping for one of the first and second SSB groups for a contention-free random access procedure.

In accordance with an exemplary embodiment, the configuration information may further indicate, for a two-step random access procedure, a first mapping ratio between a Physical Random Access Channel, PRACH, resource and a Physical Uplink Shared Channel, PUSCH, resource for the first SSB group, and a second mapping ratio between the PRACH resource and the PUSCH resource for the second SSB group.

According to a third aspect of the present disclosure, there is provided a network node in an NTN. The network node may comprise one or more processors and one or more memories comprising computer program codes. The one or more memories and the computer program codes may be configured to, with the one or more processors, cause the network node at least to perform any step of the method according to the first aspect of the present disclosure.

According to a fourth aspect of the present disclosure, there is provided a computer-readable medium having computer program codes embodied thereon which, when executed on a computer, cause the computer to perform any step of the method according to the first aspect of the present disclosure.

According to a fifth aspect of the present disclosure, there is provided a terminal device in an NTN. The terminal device may comprise one or more processors and one or more memories comprising computer program codes. The one or more memories and the computer program codes may be configured to, with the one or more processors, cause the terminal device at least to perform any step of the method according to the second aspect of the present disclosure.

According to a sixth aspect of the present disclosure, there is provided a computer-readable medium having computer program codes embodied thereon which, when executed on a computer, cause the computer to perform any step of the method according to the second aspect of the present disclosure.

With the embodiments of the present disclosure, the random access resources can be balanced in a more dynamic way to serve the use case in the NTN.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating an example architecture of a satellite radio access network;

FIG. 2A is a diagram illustrating a four-step random access procedure;

FIG. 2B is a diagram illustrating a two-step random access procedure;

FIG. 3A is a diagram illustrating a contention-free random access (CFRA) procedure with the four-step random access type;

FIG. 3B is a diagram illustrating a CFRA procedure with the two-step random access type;

FIG. 4 is a diagram illustrating RACH-ConfigGeneric information element;

FIG. 5 is a diagram illustrating an example of PRACH configuration in New Radio (NR);

FIG. 6A is a diagram illustrating an example of one SSB per PRACH occasion;

FIG. 6B is a diagram illustrating an example of two SSBs per PRACH occasion;

FIG. 7 is a diagram illustrating an example of the mapping between SSBs and preambles;

FIG. 8A is a diagram illustrating an example of the preambles for contention based random access (CBRA) and CFRA per SSB per PRACH occasion;

FIG. 8B is a diagram illustrating another example of the preambles for CBRA and CFRA per SSB per PRACH occasion;

FIG. 9 is a diagram illustrating RACH-ConfigCommon information element;

FIG. 10 is a diagram illustrating an example of the preambles for CBRA and CFRA per SSB per PRACH occasion in the two-step random access procedure;

FIG. 11 is a diagram illustrating an exemplary satellite deployment;

FIG. 12 is a flowchart illustrating a method implemented at a network node in the NTN according to some embodiments of the present disclosure;

FIG. 13A is a diagram illustrating an example of non-uniform preamble and/or RACH occasion allocation according to some embodiments of the present disclosure;

FIG. 13B is a diagram illustrating another example of non-uniform preamble and/or RACH occasion allocation according to some embodiments of the present disclosure;

FIG. 14A is a diagram illustrating an example of CFRA related information element according to some embodiments of the present disclosure;

FIG. 14B is a diagram illustrating another example of CFRA related information element according to some embodiments of the present disclosure;

FIG. 15 is a flowchart illustrating a method implemented at a terminal device in the NTN according to some embodiments of the present disclosure;

FIG. 16 is a block diagram illustrating an apparatus according to some embodiments of the present disclosure;

FIG. 17 is a block diagram illustrating an apparatus according to some embodiments of the present disclosure;

FIG. 18 is a block diagram illustrating an apparatus according to some embodiments of the present disclosure;

FIG. 19 is a block diagram illustrating a telecommunication network connected via an intermediate network to a host computer in accordance with some embodiments of the present disclosure;

FIG. 20 is a block diagram illustrating a host computer communicating via a base station with a UE over a partially wireless connection in accordance with some embodiments of the present disclosure;

FIG. 21 is a flowchart illustrating a method implemented in a communication system, in accordance with an embodiment of the present disclosure;

FIG. 22 is a flowchart illustrating a method implemented in a communication system, in accordance with an embodiment of the present disclosure;

FIG. 23 is a flowchart illustrating a method implemented in a communication system, in accordance with an embodiment of the present disclosure; and

FIG. 24 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “non-terrestrial network (NTN)” refers to a network with any flying object in the sky, such as a satellite, unmanned aircraft system (UAS), following any suitable communication standards, such as new radio (NR), long term evolution (LTE), LTE-Advanced, and so on. Furthermore, the communications between a terminal device and a network node in the NTN network may be performed according to any suitable generation communication protocols, including, but not limited to, 4G, 4.5G, 5G communication protocols, and/or any other protocols either currently known or to be developed in the future.

The term “network node” refers to a network device in the NTN network via which a terminal device accesses to the NTN network and receives services therefrom. The network node or network device may refer to a satellite, a UAS, or any flying object in the sky. More generally, however, the network node may represent any suitable device (or group of devices) capable, configured, arranged, and/or operable to enable and/or provide a terminal device access to the NTN network or to provide some service to a terminal device that has accessed to the NTN network.

The term “terminal device” refers to any end device that can access the NTN network and receive services therefrom. By way of example and not limitation, the terminal device may refer to a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

In order to better understand embodiments of the present disclosure, a brief description related to satellite communications and random access in NR will be provided firstly.

Satellite Communications

Satellite communication is a typical communication for the NTN network. A satellite radio access network usually includes the following components:
a satellite that refers to a space-borne platform;
an earth-based gateway that connects the satellite to a base station or a core network, depending on choice of architecture;
a feeder link that refers to a link between a gateway and the satellite; and
an access link/service link that refers to the link between the satellite and a UE.

Depending on an orbit altitude, a satellite may be categorized as low earth orbit (LEO) satellite, medium earth orbit (MEO) satellite, or geostationary earth orbit (GEO) satellite:
LEO satellite: typical heights ranging from 250 to 1,500 km, with an orbital period ranging from 90 to 120 minutes.
MEO satellite: typical heights ranging from 5,000 to 25,000 km, with an orbital period ranging from 3 to 15 hours.
GEO satellite: height at about 35,786 km, with an orbital period of 24 hours.

A communication satellite typically generates several beams over a given area. A footprint of a beam is usually in an elliptic shape, which has been traditionally considered as a cell. The footprint of a beam is also often referred to as a spotbeam. The spotbeam may move over the earth surface with the satellite movement or may be earth-fixed with some beam pointing mechanism used by the satellite to compensate for its motion. The size of the spotbeam depends on the system design, which may range from tens of kilometers to a few thousands of kilometers.

FIG. 1 shows an example architecture of a satellite radio access network with bent pipe transponders. The depicted elevation angle of the service link is important as it determines the distance between the satellite and the UE, and the velocity of the satellite relative to the UE. In 3GPP it has been assumed that the service link is operational for elevation angles exceeding a threshold of 10 degrees. Different locations within the spotbeam will observe different elevation angles at a given time. From the network perspective the elevation angle is often referred to relative to a reference point such as the spotbeam center in the spotbeam.

In an earth-fixed beam LEO or MEO NTN providing continuous coverage, the UE will be served by the same beam as long as the UE is in the coverage area of the satellite. Handover to a new satellite fulfilling the elevation angle threshold needs to be performed when the elevation angle to the currently serving satellite approaches the elevation angle threshold. The handover rate may be frequent, and an inter-satellite handover may be required every 450 seconds for a LEO constellation at 600 km altitude.

For LEO or MEO constellations using earth moving beams, the UE will be served by the beam that is currently passing the UE location. The UE will sequentially be served by a series of beams of the same satellite as the coverage area of the satellite passes the UE. After that, the UE will be served by a series of beams of a different satellite, etc. Thus, switching between satellite beams is even more frequent. For a LEO constellation at 600 km altitude based on earth moving beams, a handover between spotbeams may be required every 10 seconds.

Unlike the situation in terrestrial networks, the service link in NTN is typically line-of-sight (LoS) and therefore a pathloss is mainly dependent on a satellite-UE distance. Due to the geometry, the pathloss does not differ dramatically between different beams of a same satellite. For example, a pathloss range in the order of 10 dB can be expected within the coverage area of a LEO satellite at 600 km altitude. The spotbeam selectivity is mainly due to directivity of antenna lobes. The antenna lobes are approximately symmetric around each beam's center point on earth. It may therefore be feasible that cell selection/reselection is based on which spotbeam center that is closest to the UE. The UE can calculate its distance to each spotbeam center and perform distance-based cell selection/reselection using information of ephemeris and beam constellation of nearby NTN satellites together with LIE location.

Cell Search and System Information Acquisition in NR

In NR, a combination of synchronization signals (SS) and physical broadcast channel (PBCH) is referred to as a SS/PBCH block (SSB). Similar to LTE, a pair of SSs, i.e., primary synchronization signal (PSS) and secondary synchronization signal (SSS), is periodically transmitted on downlink from each base station to allow a LIE to initially access to the network. By detecting the SSs, the UE can obtain a physical cell identity, achieve downlink synchronization in both time and frequency, and acquire a timing for PBCH. PBCH carries master information block (MIB), which contains a minimum system information that the LIE is needed to acquire system information block 1 (SIB1). SIB1 carries the remaining minimum system information that is needed for the LIE to be able to perform subsequent random-access procedure.

Depending on a frequency range of a frequency band used, up to 4, 8, and 64 SSBs can be transmitted in one SSB period which can be 5 ms, 10 ms, 20 ms, 40 ms, 80 ms or 160 ms configured in SIB1. The default SSB period is 20 ms assumed for initial cell search since SIB1 is not available.

Random Access Procedure in NR

Two types of random access (RA) procedure are supported in NR, i.e., four-step RA type with Msg1 and two-step RA type with MsgA. Both types of RA procedure support contention based random access (CBRA) and contention-free random access (CFRA).

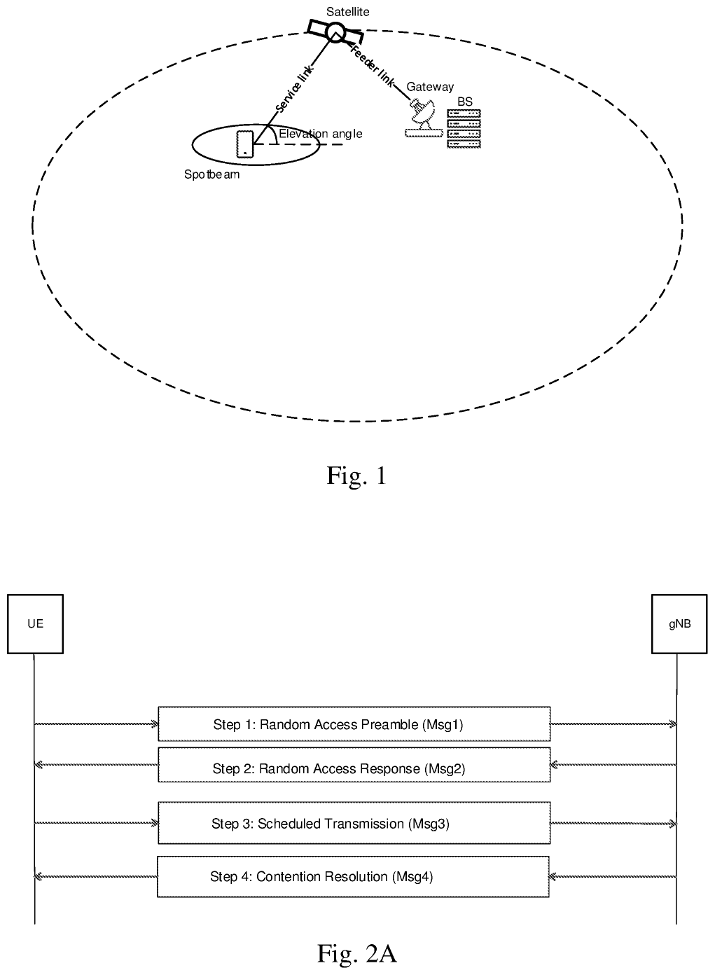

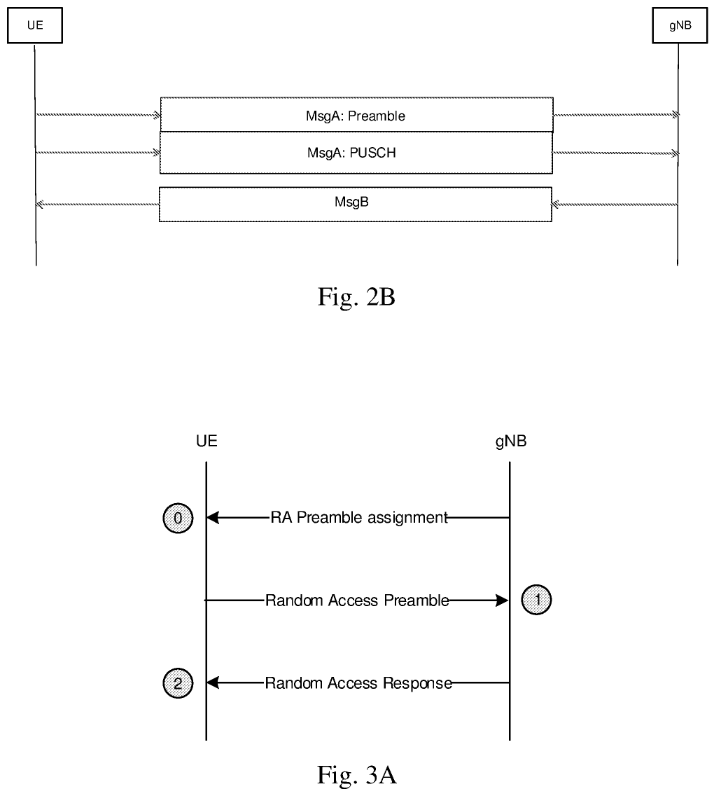

FIG. 2A illustrate the four-step CBRA procedure which is also referred to as Type-1 random access procedure in TS 38.213 V16.3.0. In Step 1, the UE initiates the random access procedure by transmitting in uplink (UL) a random access preamble (i.e., Msg 1) on a physical random access channel (PRACH). After detecting the Msg1, the gNB will respond by transmitting in downlink (DL) a random-access response (RAR) (i.e., Msg2) on a physical downlink shared channel (PDSCH), in Step 2. In Step 3, after successfully decoding the Msg2, the UE continues the random access procedure by transmitting in UL a physical uplink shared channel (PUSCH) (i.e., Msg3) for terminal identification and RRC connection establishment request. In Step 4, the gNB transmits in DL a PDSCH (i.e., Msg4) for contention resolution.

There can be cases where multiple UEs select the same random access preamble and transmit the preamble on the same PRACH time/frequency resource. The preamble collision can be seen as a contention. One of the main purposes of applying Step 3 and Step 4 is to resolve such potential contention.

FIG. 2B illustrates the two-step random access procedure which is also referred to as Type-2 random access procedure in TS 38.213 V16.3.0. In the first step, the UE transmits a message MsgA including a random access preamble together with higher layer data such as RRC connection request possibly with some small payload on PUSCH. After detecting the MsgA, the gNB transmits RAR (which is also called msgB) including UE identifier assignment, timing advance information, and contention resolution message etc.

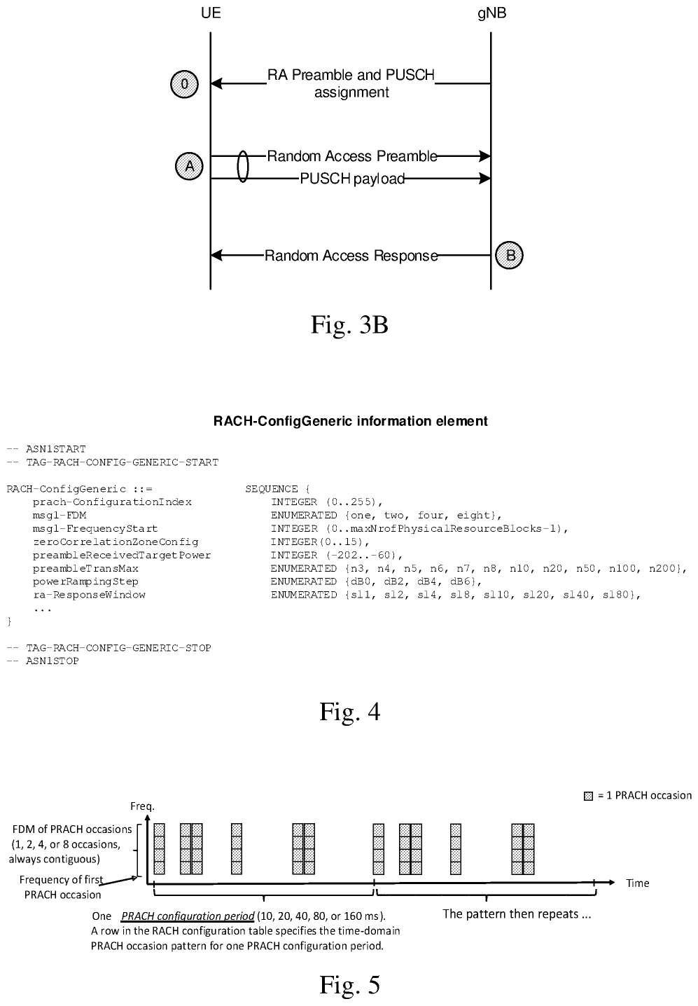

FIGS. 3A and 3B illustrate the CFRA procedures with the four-step random access type and the two-step random access type respectively. In FIG. 3A, the gNB assigns the RA preamble, while in FIG. 3B, the gNB assigns the RA preamble and PUSCH. The gNB does not configure CFRA resources for the four-step and two-step RA types at the same time for a Bandwidth Part (BWP). The CFRA with two-step RA type is only supported for handover.

As shown in FIGS. 3A and 3B, the Msg1 includes only a preamble on PRACH, while the MsgA includes a preamble on PRACH and a payload on PUSCH. After the Msg1 transmission or MsgA transmission, the UE monitors for a RAR from the gNB within a configured window. For the CFRA procedure, upon receiving the RAR, the UE ends the random access procedure.

PRACH Configuration and SSB to RACH Occasion Mapping in the Four-Step RA Procedure in NR

In NR, a time and frequency resource on which a random access preamble (i.e., Msg 1) is transmitted is defined as a PRACH occasion.

Time resources and preamble format for the Msg1 transmission is configured by a PRACH configuration index, which indicates a row in a PRACH configuration table specified in TS 38.211 V16.3.0 Tables 6.3.3.2-2, 6.3.3.2-3, 6.3.3.2-4 for FR1 paired spectrum, FR1 unpaired spectrum and FR2 with unpaired spectrum, respectively.

Part of the Table 6.3.3.2-3 for FR1 unpaired spectrum for preamble format 0 is shown in Table 1 below. The value of x indicates a PRACH configuration period in number of system frames. The value of y indicates a system frame within each PRACH configuration period on which PRACH occasions are configured. For instance, if y is set to 0, it means that the PRACH occasions only are configured in the first frame of each PRACH configuration period. The values in the column “Subframe number” indicate on which subframes are configured with the PRACH occasion. The values in the column “Starting symbol” is a symbol index indicating from which symbol the first PRACH occasion starts in a PRACH slot.

TABLE 1
PRACH configuration for preamble format 0 for FR1 unpaired spectrum

| | | | | | | Number of | Nₜ^{RA, slot}, | |
|---|---|---|---|---|---|---|---|---|
| PRACH | | | | | | PRACH | number of time-domain | N_{dur}^{RA}, |
| Configuration | Preamble | n_{SFN} mod x = y | | Subframe | Starting | slots within | PRACH occasions within | PRACH |
| Index | format | x | y | number | symbol | a subframe | a PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |
| 10 | 0 | 1 | 0 | 6 | 0 | — | — | 0 |
| 11 | 0 | 1 | 0 | 5 | 0 | — | — | 0 |
| 12 | 0 | 1 | 0 | 4 | 0 | — | — | 0 |
| 13 | 0 | 1 | 0 | 3 | 0 | — | — | 0 |
| 14 | 0 | 1 | 0 | 2 | 0 | — | — | 0 |
| 15 | 0 | 1 | 0 | 1, 6 | 0 | — | — | 0 |
| 16 | 0 | 1 | 0 | 1, 6 | 7 | — | — | 0 |
| 17 | 0 | 1 | 0 | 4, 9 | 0 | — | — | 0 |
| 18 | 0 | 1 | 0 | 3, 8 | 0 | — | — | 0 |
| 19 | 0 | 1 | 0 | 2, 7 | 0 | — | — | 0 |
| 20 | 0 | 1 | 0 | 8, 9 | 0 | — | — | 0 |
| 21 | 0 | 1 | 0 | 4, 8, 9 | 0 | — | — | 0 |
| 22 | 0 | 1 | 0 | 3, 4, 9 | 0 | — | — | 0 |
| 23 | 0 | 1 | 0 | 7, 8, 9 | 0 | — | — | 0 |
| 24 | 0 | 1 | 0 | 3, 4, 8, 9 | 0 | — | — | 0 |
| 25 | 0 | 1 | 0 | 6, 7, 8, 9 | 0 | — | — | 0 |
| 26 | 0 | 1 | 0 | 1, 4, 6, 9 | 0 | — | — | 0 |
| 27 | 0 | 1 | 0 | 1, 3, 5, 7, 9 | 0 | — | — | 0 |

In case of Time Division Duplex (TDD), semi-statically configured DL parts and/or actually transmitted SSBs can override and invalidate some time-domain PRACH occasions defined in the PRACH configuration table. More specifically, PRACH occasions in the UL part are always valid, and a PRACH occasion within the X part is valid as long as it does not precede or collide with an SSB in the PRACH slot and it is at least N symbols after the DL part and the last symbol of an SSB. N is 0 or 2 depending on PRACH format and subcarrier spacing.

In the frequency domain, NR supports multiple frequency-multiplexed PRACH occasions on the same time-domain PRACH occasion. This is mainly motivated by the support of analog beam sweeping in NR such that the PRACH occasions associated to one SSB are configured at the same time instance but different frequency locations. The starting position in the frequency is indicated by the higher-layer parameter msg1-FrequencyStart in SIB 1, and the number of consecutive PRACH occasions frequency-multiplexed in one time instance is configured by the higher-layer parameter msg1-FDMin SIB1. The number of PRACH occasions frequency-multiplexed in one time domain PRACH occasion can be 1, 2, 4, or 8.

FIG. 4 illustrates RACH-ConfigGeneric information element defined in 3GPP TS 38.331 v16.2.0. RACH-ConfigGeneric information element contains msg1-FDM and msg1-FrequencyStart as below:
msg1-FDM indicates the number of PRACH occasions frequency-multiplexed in one time instance; and
msg1-FrequencyStart indicates an offset of the lowest PRACH occasion in frequency domain with respective to physical resource block (PRB) 0. The value is configured so that the corresponding RACH resource is entirely within the bandwidth of the UL BWP.

FIG. 5 illustrates an example of PRACH configuration in NR. In NR Release 15, there are up to 64 sequences that can be used as random access preambles per PRACH occasion in each cell. The RRC parameter totalNumberOfRA-Preambles determines how many of these 64 sequences are used as the random access preambles per PRACH occasion in each cell. The 64 sequences are configured by including firstly all the available cyclic shifts of a root Zadoff-Chu sequence, and secondly in the order of increasing root index, until 64 preambles have been generated for the PRACH occasion.

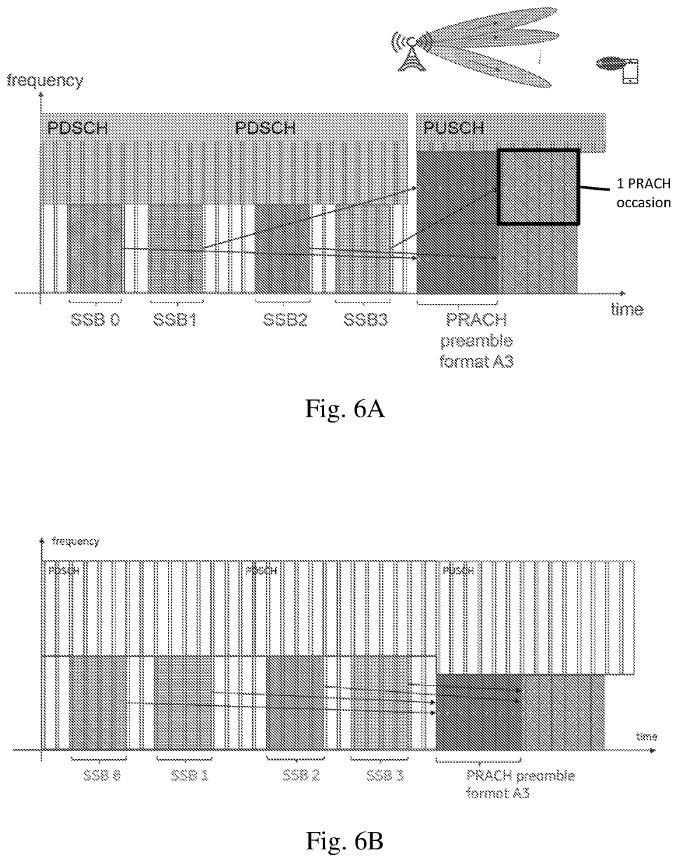

NR Release 15 supports one-to-one, one-to-many, and many-to-one association between SSB and PRACH occasion. FIGS. 6A and 6B illustrate one-to-one association and two-to-one association between SSB and PRACH occasion.

The preambles associated to each SSB is configured by two RRC parameters in RACH-ConfigCommon information element: ssb-perRACH-OccasionAndCB-PreamblesPerSSB and totalNumberOfRA-Preambles.

3GPP TS 38.213 V16.3.0 section 8.1 specifies the detailed mapping rule as follows:

For Type-1 random access procedure, a UE is provided a number N of SS/PBCH blocks associated with one PRACH occasion and a number R of contention based preambles per SS/PBCH block per valid PRACH occasion by ssb-perRACH-OccasionAndCB-PreamblesPerSSB.

A UE is provided a number N of SS/PBCH blocks associated with one PRACH occasion and a number R of contention-based preambles per SS/PBCH block per valid PRACH occasion by ssb-perRACH-OccasionAndCB-PreamblesPerSSB. If N<1, one SS/PBCH block is mapped to 1/N consecutive valid PRACH occasions and R contention based preambles with consecutive indexes associated with the SS/PBCH block per valid PRACH occasion start from preamble index 0. If N≥1, R contention based preambles with consecutive indexes associated with SS/PBCH block n, 0≤n≤N−1, per valid PRACH occasion start from preamble index n·N_{preamble}^{total}/N, where N_{preamble}^{total} is provided by totalNumberOfRA-Preambles and is an integer multiple of N.

SS/PBCH block indexes provided by ssb-PositionsInBurst in SIB1 or in ServingCellConfigCommon are mapped to valid PRACH occasions in the following order where the parameters are described in 3GPP TS 38.211 V16.3.0:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

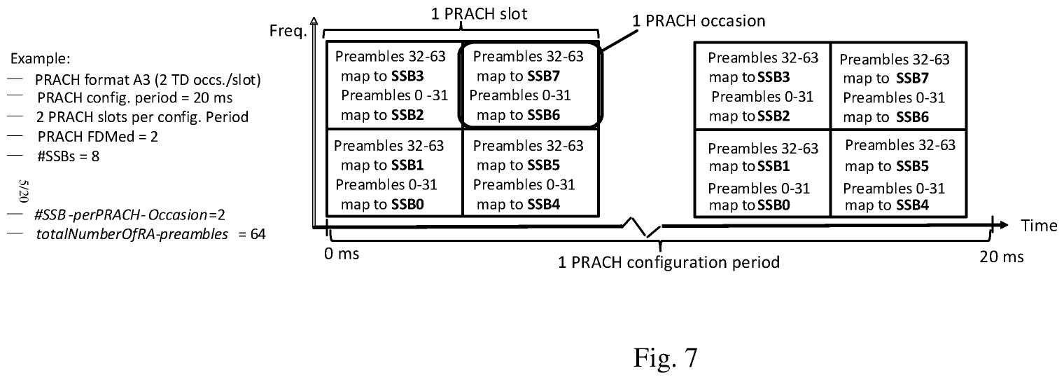

FIG. 7 shows an example of the mapping between SSBs and preambles in different PRACH occasions. In this example, there are two PRACH slots in one PRACH configuration period, and two PRACH occasions frequency-multiplexed in one time domain PRACH occasion. Also there are total eight SSBs, and two SSBs are associated with one PRACH occasion.

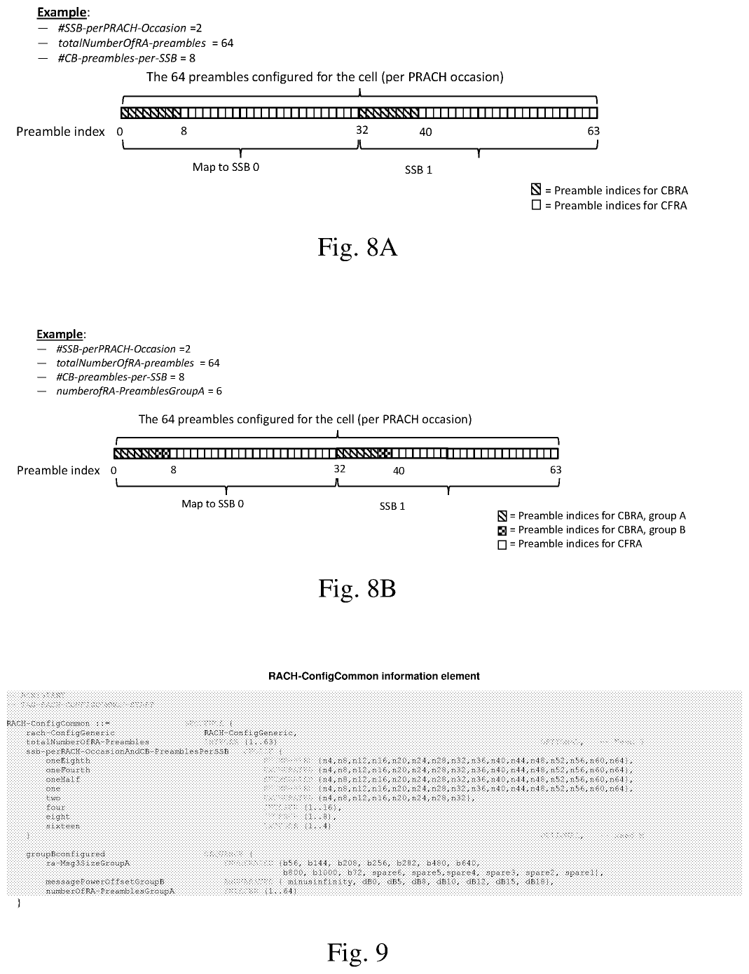

For each SSB, the associated preambles per PRACH occasion, N_{preamble}^{total}/N are further divided into two sets for CBRA and CFRA. The number of CBRA preambles per SSB per PRACH occasion, R, is signaled by the RRC parameter ssb-perRACH-OccasionAndCB-PreamblesPerSSB. The preamble indices for CBRA and CFRA are mapped consecutively for one SSB in one PRACH occasion, as shown in FIG. 8A.

If random access preambles group B is configured for CBRA, amongst the CBRA preambles (#CB-preambles-per-SSB) associated with an SSB, the first numberOfRA-PreamblesGroupA random access preambles belong to random access preambles group A, and the remaining random access preambles associated with the SSB belong to random access preambles group B. FIG. 8B shows an example when random access preambles group B is configured for CBRA.

According to TS 38.213 V16.3.0, one of two conditions must be met in order for a UE to select random access preambles group B for PRACH transmission. Condition 1 is that potential Msg3 size (UL data available for transmission plus a medium access control (MAC) header and, where required, MAC control elements (CEs)) is greater than ra-Msg3SizeGroupA and the pathloss is less than PCMAX (of the serving cell performing the random access procedure)−preambleReceivedTargetPower−msg3-DeltaPreamble−messagePowerOffsetGroupB. Condition 2 is that the random access procedure was initiated for common control channel (CCCH) logical channel and CCCH service data unit (SDU) size plus MAC subheader is greater than ra-Msg3SizeGroupA. FIG. 9 illustrates RACH-ConfigCommon information element in which ra-Msg3SizeGroupA, messagePowerOffsetGroupB and numberOfRA-PreamblesGroupA are defined.

MsgA PRACH Part Configuration and SSB to RACH Occasion Mapping in Two-Step RA Procedure in NR R16

The RA occasions for the two-step RA procedure can be either separately configured (also known as Type-2 random access procedure with separate configuration of PRACH occasions with Type-1 random access procedure) or shared with the four-step RA procedure (also known as Type-2 random access procedure with common configuration of PRACH occasions with Type-1 random access procedure) in which case different set of preamble identifiers will be used.

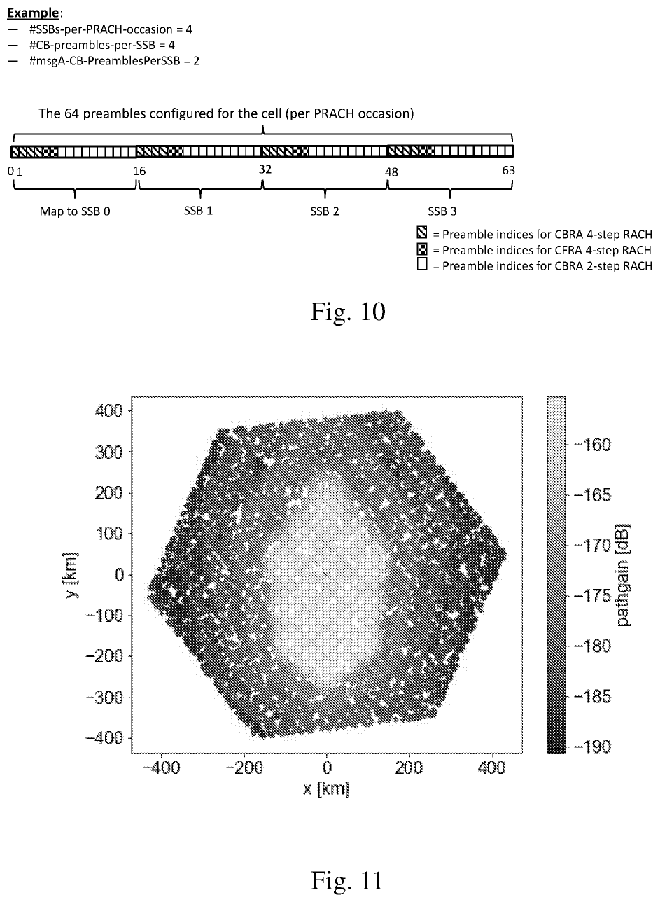

For the Type-2 random access procedure with common configuration of PRACH occasions with Type-1 random access procedure, a UE is provided with a number N of SS/PBCH blocks associated with one PRACH occasion by ssb-perRACH-OccasionAndCB-PreamblesPerSSB and a number Q of contention based preambles per SS/PBCH block per valid PRACH occasion by msgA-CB-PreamblesPerSSB. The PRACH transmission can be on a subset of PRACH occasions associated with a same SS/PBCH block index for a UE provided with a PRACH mask index by msgA-ssb-sharedRO-MaskIndex. An example of the SSB to RACH occasion mapping and the preamble allocation is provided in FIG. 10. Note that only one preamble group is assumed in this example.

For the Type-2 random access procedure with separate configuration of PRACH occasions with Type-1 random access procedure, a UE is provided with a number N of SS/PBCH blocks associated with one PRACH occasion and a number R of contention based preambles per SS/PBCH block per valid PRACH occasion by ssb-perRACH-OccasionAndCB-PreamblesPerSSB-msgA when provided, otherwise, by ssb-perRACH-OccasionAndCB-PreamblesPerSSB. Since the SSB to RACH occasion mapping and the preamble allocation are independently configured, the example provided for the four-step RA procedure in FIG. 8B is also valid for this case of the two-step RA procedure except that the parameters are separately configured for the two-step RA procedure.

In terrestrial networks, targeted coverage and utilization of individual SSB beams (which are the beams for transmitting the SSBs) are considered to be roughly equal. However, in a satellite cell, the beams are often of unequal size owing to: 1) the geometry of the satellite deployment, whereby some cells that are directly beneath the satellite will be smaller compared to the cells that are at an elevation angle, as shown in FIGS. 11, and 2) different sizes of beams that are used for different purposes, such as one wide beam being used for coverage and narrow beams being used for high-capacity. FIG. 11 shows a satellite deployment of 19 cells at an elevation angle. The cells at the bottom are at an elevation angle close to 90 degrees, whereas the cells on the top are at a much lower elevation angle which produces an elongating of the cell and the cellular pattern of cells.

As an example of how spotbeams are utilized in a more dynamic way in several satellite networks (which do not use 3GPP-solutions and are not necessarily solved in this disclosure), it is common to utilize different size of spotbeams for uplink and downlink in satellite deployments.

In current 3GPP specifications, it is always even number of preambles that are allocated for each SSB when performing random access. However, in the NTN network, the beams within a satellite cell are often of unequal size. It is desirable for a solution of configuring the random access resources to SSB mapping when the sizes of the beams are unequal in the NTN network.

In accordance with some exemplary embodiments, the present disclosure provides a solution for flexible random access resource mapping. The solution may be applied to the NTN network including a terminal device such as a UE and a network node such as a satellite. With the solution, the network node can balance the random access resource in a more dynamic way to serve use cases or expected distribution of UEs in the NTN network.

It is noted that some embodiments of the present disclosure are mainly described in relation to NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does not limit the present disclosure naturally in any way. Rather, any other system configuration or radio technologies may equally be utilized as long as exemplary embodiments described herein are applicable.

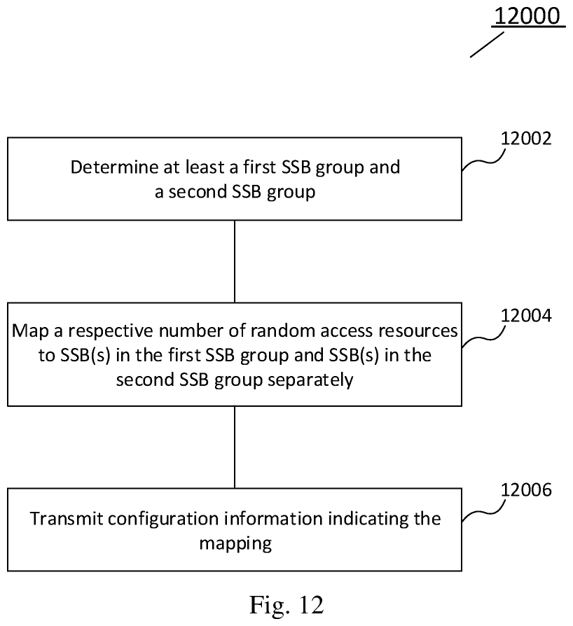

FIG. 12 is a flowchart illustrating a method 12000 according to some embodiments of the present disclosure. The method 12000 illustrated in FIG. 12 may be performed by an apparatus implemented in/as a network node or communicatively coupled to a network node in the NTN network. In accordance with an exemplary embodiment, the network node may be a satellite.

According to the exemplary method 12000 illustrated in FIG. 12, the network node determines at least a first SSB group and a second SSB group, as shown in block 12002. The first SSB group and the second SSB group may each comprise one or more SSBs. In some embodiments, the first SSB group may be used for wide beams, and the second SSB group may be used for narrow beams. Since in the NTN network, the sizes of beams are not necessarily the same and the coverage might be different for each beam, whereby some beams might be able to provide more. Thus, the first SSB group and the second SSB group may be allocated random access resources separately.

In block 12004, the network node maps a respective number of random access resources to the one or more SSBs in the first SSB group and the one or more SSBs in the second SSB group separately. Thus, the SSB(s) in the first SSB group can be mapped to a certain number of random access resources, and the SSB(s) in the second group can be mapped to another number of random access resources. In some embodiments, the mapping between SSB and random access resources may be allowed to be non-uniformly allocated for the first SSB group and the second SSB group. Each of the first SSB group and the second SSB group can be for instance configured by a separate SSB configuration ssb-perRACH-OccasionAndCB-PreamblesPerSSB per group. This enables the network node to allocate certain random access resources to specific SSB groups without much change for the UE, as the UE only has to detect and select the SSB and then use the random access resources that correspond to the selected SSB.

In some embodiments, the network node may allocate a first number of preambles to each SSB of the first SSB group, and allocate a second number of preambles to each SSB of the second SSB group. Thus, each of the SSB(s) in the first SSB group is associated to the first number of preambles, and each of the SSB(s) in the second SSB group is associated to the second number of preambles.

In some embodiments, the first number may be different from the second number, depending on sizes of beams for which the first SSB group and the second SSB group are used and/or a beam deployment in a coverage of the network node. For example, if a wide beam covers a larger area with a larger amount of expected terminal devices while a narrow beam covers a smaller area with a smaller amount of expected terminal devices, the SSB(s) in the first SSB group for wide beams will be allocated a larger number of preambles than the SSB(s) in the second SSB group for narrow beams, that is, the first number is larger than the second number. If the wide beam covers a larger area with a smaller amount of expected terminal devices while the narrow beam covers a smaller area with a larger amount of expected terminal devices, the SSB(s) in the first SSB group for wide beams will be allocated a smaller number of preambles than the SSB(s) in the second SSB group for narrow beams, that is, the first number is smaller than the second number. This could for instance be useful when the narrow beams are used to cover smaller areas that have more terminal devices according to the requirements, such as cities, farms with IoT devices, flight/shipping corridors etc. Therefore, the number of preambles can be allocated individually per beam.

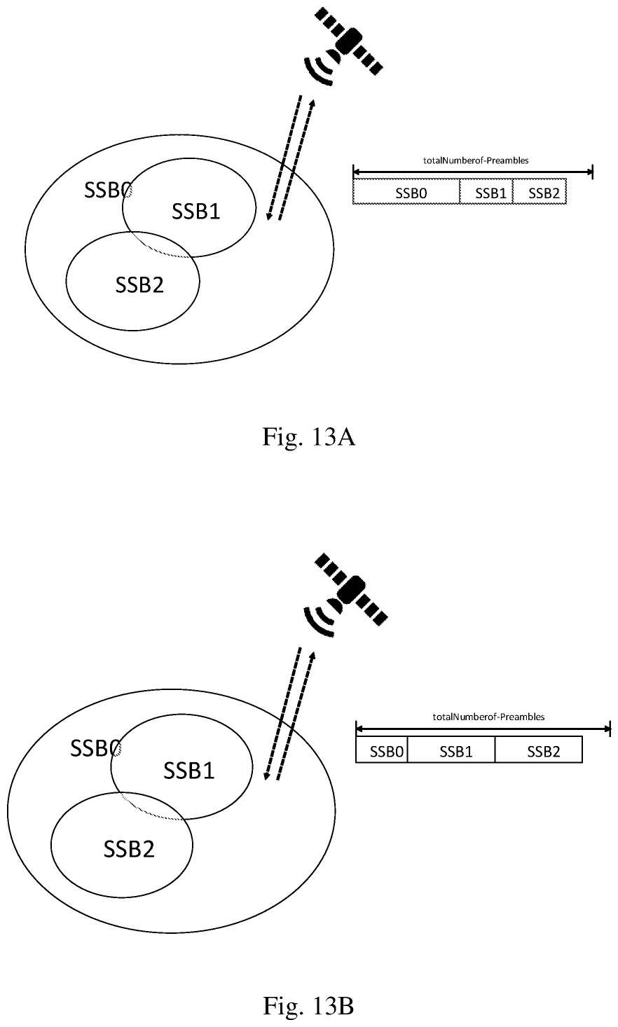

FIG. 13A illustrates the scenario in which the wide beam covers a larger area with a larger amount of terminal devices and the narrow beam covers a smaller area with a smaller amount of terminal devices. In this scenario, the first SSB group comprising SSB0 is used for the wide beam, and the second SSB group comprising SSB1 and SSB2 is used for the narrow beams. SSB0 is allocated with a larger number of preambles compared to SSB1 and SSB2. SSB1 and SSB2 are allocated with the same number of preambles.

FIG. 13B illustrates the scenario in which the wide beam covers a larger area with a smaller amount of terminal devices and the narrow beam covers a smaller area with a larger amount of terminal devices. In this scenario, the first SSB group comprising SSB0 is used for the wide beam, and the second SSB group comprising SSB1 and SSB2 is used for the narrow beams. SSB0 is allocated with a smaller number of preambles than SSB1 and SSB2. SSB1 and SSB2 are allocated with the same number of preambles.

In some embodiments, the network node may map a first set of RACH occasions to the SSB(s) in the first SSB group, and map a second set of RACH occasions to the SSB(s) in the second SSB group. Thus, each of the SSB(s) in the first SSB group is mapped to the first set of RACH occasions and each of the SSB(s) in the second SSB group is mapped to the second set of RACH occasions. In some embodiments, the number of RACH occasions in the first set of RACH occasions may be different from the number of RACH occasions in the second set of RACH occasions, depending on sizes of beams for which the first SSB group and the second SSB group are used and/or a beam deployment in a coverage of the network node. For example, the number of RACH occasions mapped to the first SSB group for wide beams may be larger than the number of RACH occasions mapped to the second SSB group for narrow beams. Accordingly, the SSB(s) in the first SSB group can be mapped to more RACH occasions than the SSB(s) in the second SSB group, and the SSB(s) in the first SSB group may have more chances to be selected.

In some embodiments, the network node may configure a first SSB to RACH occasion mapping for the first SSB group, and configure a second SSB to RACH occasion mapping for the second SSB group. In some embodiments, the first SSB to RACH occasion mapping may be different from the second SSB to RACH occasion mapping. For example, in the scenario as shown in FIG. 13A, SSB0 is mapped to one RACH occasion, and both SSB0 and SSB1 are mapped to one RACH occasion. Therefore, for the first SSB group, the first SSB to RACH occasion is one to one, and for the second SSB group, the second SSB to RACH occasion is two to one.

Then in block 12006, the network node transmits configuration information indicating the mapping between the SSB(s) in the first SSB group and the random access resources and the mapping between the SSB(s) in the second SSB group and the random access resources. For contention based random access, the network node may broadcast the configuration information via PBCH. For contention free random access, the network node may transmit the configuration information to a particular terminal device.

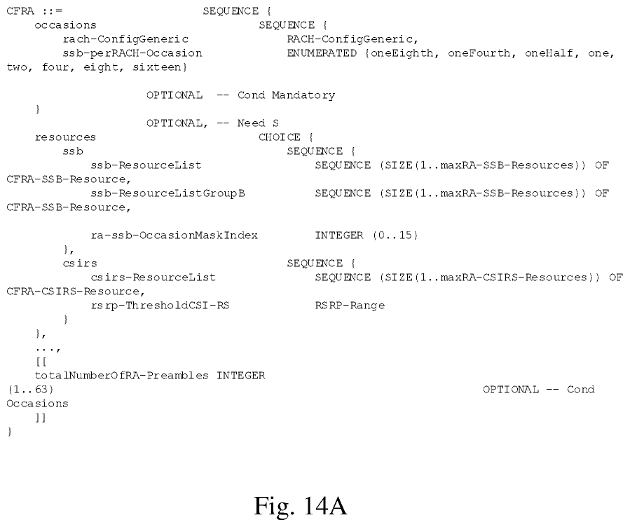

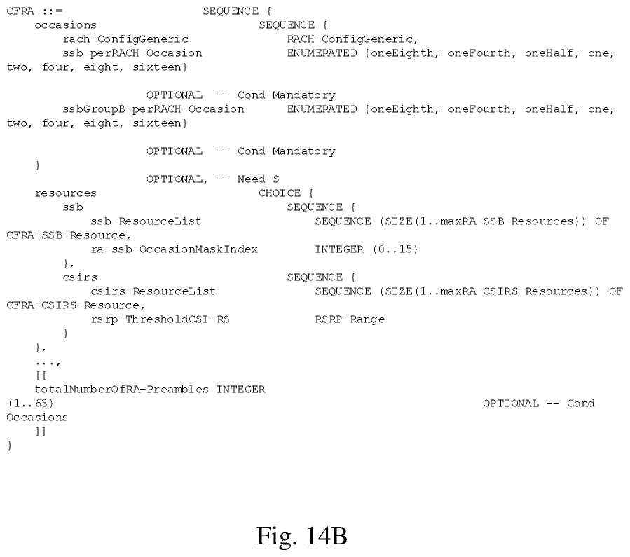

Additionally, in some embodiments, the network node may configure a dedicated SSB resource list for one of the first and second SSB groups for the CFRA procedure. The SSB resource in the dedicated SSB resource list indicates one or more SSB indices and one or more preamble identifiers. In some embodiments, the dedicated SSB resource list may be configured for the SSB(s) in the first SSB group for wide beams. Then the dedicated SSB resource list may be indicated in the configuration information. FIG. 14A illustrates part of related CFRA information element in which ssb-ResourceListGroupB indicates the dedicated SSB resource list.

Additionally, in some embodiments, the network node may configure a dedicated SSB to RACH occasion mapping for one of the first and second SSB groups for the CFRA procedure. The dedicated SSB to RACH occasion mapping may be configured for the SSB(s) in the first SSB group for wide beams. Then the dedicated SSB to RACH occasion mapping may be indicated in the configuration information. FIG. 14B illustrates part of related CFRA information element in which ssbGroupB-perRACH-Occasion indicates the dedicated SSB to RACH occasion mapping.

As described above, some SSB(s) may have a larger number of preambles and/or RACH occasions allocated to it. Similarly, this can be extended to the two-step random access procedure by introducing more msgA PUSCH resources for a SSB group for a specific beam. By allowing for larger number of preambles and/or RACH occasions, the number of msgA PUSCH resources can be implicitly extended.

In NR Release 16, in the two-step random access procedure, MsgA preamble is mapped to MsgA PUSCH resources with some mapping ratio determined by the total number of PRACH and PUSCH resources configured in one SSB to RO association pattern period defined in TS 38.213 V16.3.0. This mapping ratio can be different for different beams that the corresponding PRACH resources are mapped to. For example, the PUSCH resources mapped to the PRACH resources corresponding to narrower beam can be more than that for wide beam so that more robust of MsgA PUSCH can be ensured.

In some embodiments, for the two-step random access procedure, the network node may determine a first mapping ratio between PRACH resource and PUSCH resource for the first SSB group, and determine a second mapping ratio between the PRACH resource and the PUSCH resource for the second SSB group. The first mapping ratio may be different from the second mapping ratio. Then the first mapping ratio and the second mapping ratio may be indicated in the configuration information.

Additionally, when a terminal device initiates a random access procedure, the network node may receive a preamble on a RACH occasion from the terminal device. Then the network node may determine the SSB that was used by the terminal device, based on the received preamble and the RACH occasion. Accordingly, the network node may determine the corresponding beam. Then the network node may use this beam to transmit subsequent message(s) such as RAR.

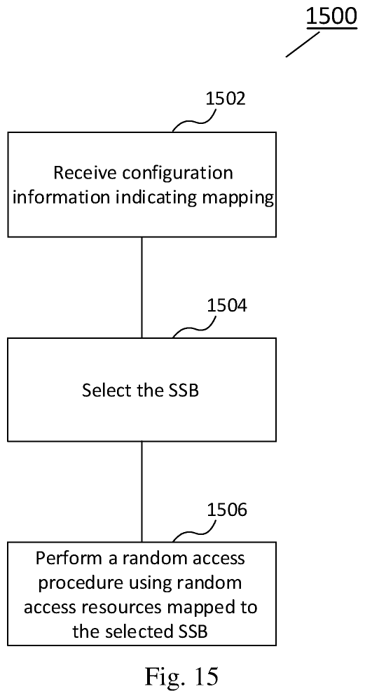

FIG. 15 is a flowchart illustrating a method 1500 according to some embodiments of the present disclosure. The method 1500 illustrated in FIG. 15 may be performed by an apparatus implemented in/as a terminal device in the NTN network or communicatively coupled to a terminal device in the NTN network. In accordance with an exemplary embodiment, the terminal device may be a UE or a NB-IoT device. In the following description with respect to FIG. 15, for the same or similar parts as those in the previous exemplary embodiments, the detailed description will be properly omitted.

According to the exemplary method 1500 illustrated in FIG. 15, the UE receives configuration information from a network node in the NTN, as shown in block 1502. The configuration indicates a mapping of a respective number of random access resources to one or more SSBs in a first SSB group and one or more SSBs in a second SSB group. In some embodiments, the network node may be a satellite. In some embodiments, the first SSB group may be used for wide beams, and the second SSB group may be used for narrow beams.

In some embodiments, the mapping may comprise a first number of preambles being allocated to each SSB of the first SSB group, and a second number of preambles being allocated to each SSB of the second SSB group. In some embodiments, the mapping may comprise a first set of RACH occasions being mapped to the one or more SSBs in the first SSB group, and a second set of RACH occasions being mapped to the one or more SSBs in the second SSB group. In some embodiments, the mapping may comprise a first SSB to random access channel, RACH, occasion mapping being configured for the first SSB group, and a second SSB to RACH occasion mapping being configured for the second SSB group.

In some embodiments, the configuration information may further indicate a dedicated SSB resource list for one of the first and second SSB groups for a contention-free random access procedure. In some embodiments, the configuration information may further indicate a dedicated SSB to RACH occasion mapping for one of the first and second SSB groups for a contention-free random access procedure. In some embodiments, the configuration information may further indicate, for the two-step random access procedure, a first mapping ratio between PRACH resource and PUSCH resource for the first SSB group, and a second mapping ratio between the PRACH resource and the PUSCH resource for the second SSB group.

In block 1504, the UE selects the SSB of the first SSB group or the second SSB group. In some embodiments, the UE may select the SSB based on detection of a beam. Then the UE may determine the random access resource mapped to the selected SSB according to the received configuration information. Then in block 1506, the UE may perform a random access procedure using the determined random access resource mapped to the selected SSB.

Although blocks 1502 and 1504 are shown in a sequential order, a person skilled in the art will appreciate that block 1502 does not have to be performed before block 1504, and blocks 1502 and 1504 can be performed in any other order or substantially concurrently.

It can be therefore seen that, with the proposed solutions of flexible random access resource mapping in NTN according to the above embodiments, the random access resources can be allocated per beam.

The various blocks shown in FIGS. 12 and 15 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

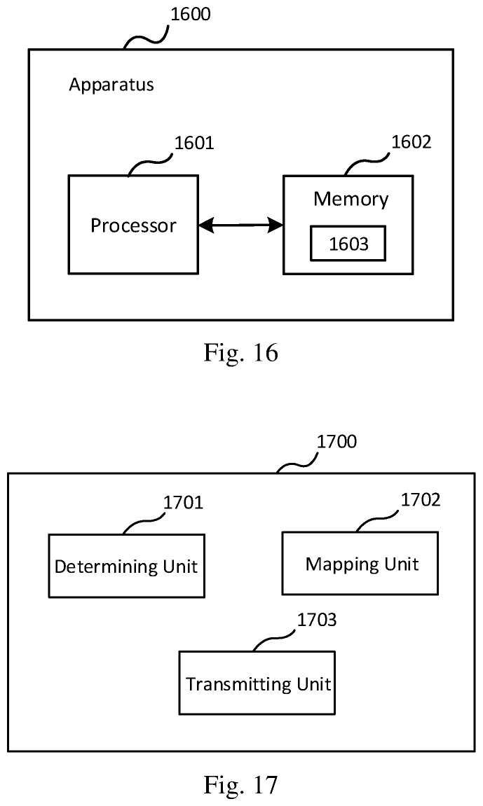

FIG. 16 is a block diagram illustrating an apparatus 1600 according to various embodiments of the present disclosure. As shown in FIG. 16, the apparatus 1600 may comprise one or more processors such as processor 1601 and one or more memories such as memory 1602 storing computer program codes 1603. The memory 1602 may be non-transitory machine/processor/computer readable storage medium. In accordance with some exemplary embodiments, the apparatus 1600 may be implemented as an integrated circuit chip or module that can be plugged or installed into a network node as described with respect to FIG. 12, or a terminal device as described with respect to FIG. 15.

In some implementations, the one or more memories 1602 and the computer program codes 1603 may be configured to, with the one or more processors 1601, cause the apparatus 1600 at least to perform any operation of the method as described in connection with FIG. 12. In such embodiments, the apparatus 1600 may be implemented as at least part of or communicatively coupled to the network node as described above. As a particular example, the apparatus 1600 may be implemented as a network node.

In other implementations, the one or more memories 1602 and the computer program codes 1603 may be configured to, with the one or more processors 1601, cause the apparatus 1600 at least to perform any operation of the method as described in connection with FIG. 15. In such embodiments, the apparatus 1600 may be implemented as at least part of or communicatively coupled to the terminal device as described above. As a particular example, the apparatus 1600 may be implemented as a terminal device.

Alternatively or additionally, the one or more memories 1602 and the computer program codes 1603 may be configured to, with the one or more processors 1601, cause the apparatus 1600 at least to perform more or less operations to implement the proposed methods according to the exemplary embodiments of the present disclosure.

FIG. 17 is a block diagram illustrating an apparatus 1700 according to some embodiments of the present disclosure. As shown in FIG. 17, the apparatus 1700 may comprise a determining unit 1701, a mapping unit 1702, and a transmitting unit 1703. In an exemplary embodiment, the apparatus 1700 may be implemented in a network node such as a satellite. The determining unit 1701 may be operable to carry out the operation in block 12002. The mapping unit 1702 may be operable to carry out the operation in block 12004. The transmitting unit 1703 may be operable to carry out the operation in block 12006. Optionally, the determining unit 1701 and/or the mapping unit 1702 and/or the transmitting unit 1703 may be operable to carry out more or less operations to implement the proposed methods according to the exemplary embodiments of the present disclosure.

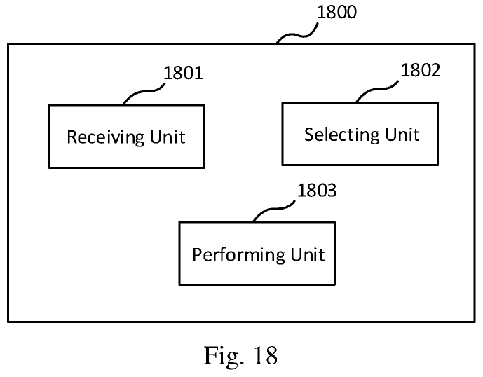

FIG. 18 is a block diagram illustrating an apparatus 1800 according to some embodiments of the present disclosure. As shown in FIG. 18, the apparatus 1800 may comprise a receiving unit 1801, a selecting unit 1802, and a performing unit 1803. In an exemplary embodiment, the apparatus 1800 may be implemented in a terminal device such as a UE. The receiving unit 1801 may be operable to carry out the operation in block 1502. The selecting unit 1802 may be operable to carry out the operation in block 1504. The performing unit 1803 may be operable to carry out the operation in block 1506. Optionally, the receiving unit 1801 and/or the selecting unit 1802 and/or the performing unit 1803 may be operable to carry out more or less operations to implement the proposed methods according to the exemplary embodiments of the present disclosure.

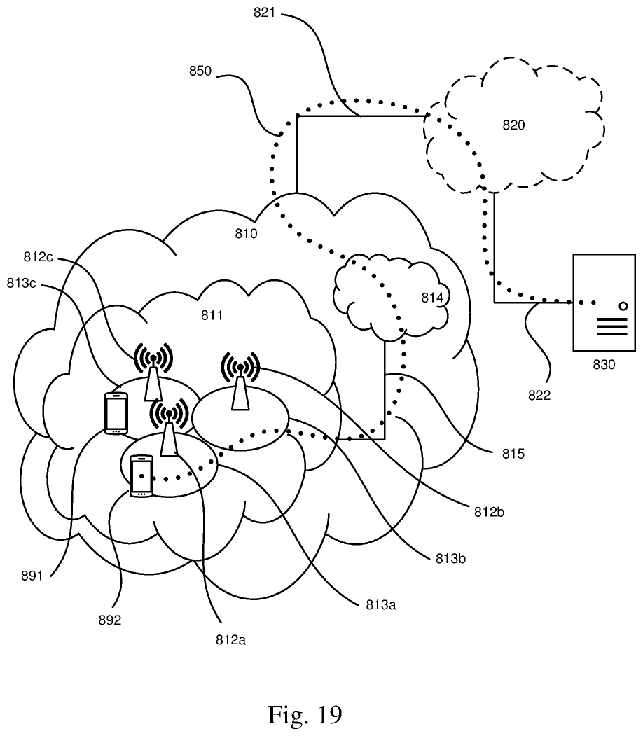

FIG. 19 is a block diagram illustrating a telecommunication network connected via an intermediate network to a host computer in accordance with some embodiments of the present disclosure.

With reference to FIG. 19, in accordance with an embodiment, a communication system includes a telecommunication network 810, such as a 3GPP-type cellular network, which comprises an access network 811, such as a radio access network, and a core network 814. The access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to the core network 814 over a wired or wireless connection 815. A first UE 891 located in a coverage area 813c is configured to wirelessly connect to, or be paged by, the corresponding base station 812c. A second UE 892 in a coverage area 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

The telecommunication network 810 is itself connected to a host computer 830, which may be embodied in the hardware and/or software of a standalone server, a cloud-implemented server, a distributed server or as processing resources in a server farm. The host computer 830 may be under the ownership or control of a service provider, or may be operated by the service provider or on behalf of the service provider. Connections 821 and 822 between the telecommunication network 810 and the host computer 830 may extend directly from the core network 814 to the host computer 830 or may go via an optional intermediate network 820. An intermediate network 820 may be one of, or a combination of more than one of, a public, private or hosted network; the intermediate network 820, if any, may be a backbone network or the Internet; in particular, the intermediate network 820 may comprise two or more sub-networks (not shown).

The communication system of FIG. 19 as a whole enables connectivity between the connected UEs 891, 892 and the host computer 830. The connectivity may be described as an over-the-top (OTT) connection 850. The host computer 830 and the connected UEs 891, 892 are configured to communicate data and/or signaling via the OTT connection 850, using the access network 811, the core network 814, any intermediate network 820 and possible further infrastructure (not shown) as intermediaries. The OTT connection 850 may be transparent in the sense that the participating communication devices through which the OTT connection 850 passes are unaware of routing of uplink and downlink communications. For example, the base station 812 may not or need not be informed about the past routing of an incoming downlink communication with data originating from the host computer 830 to be forwarded (e.g., handed over) to a connected UE 891. Similarly, the base station 812 need not be aware of the future routing of an outgoing uplink communication originating from the UE 891 towards the host computer 830.

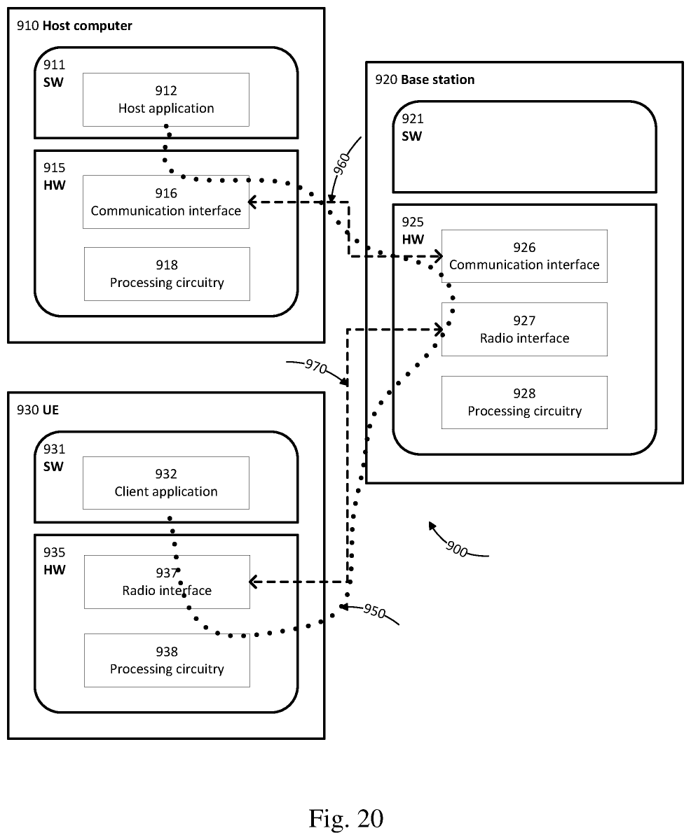

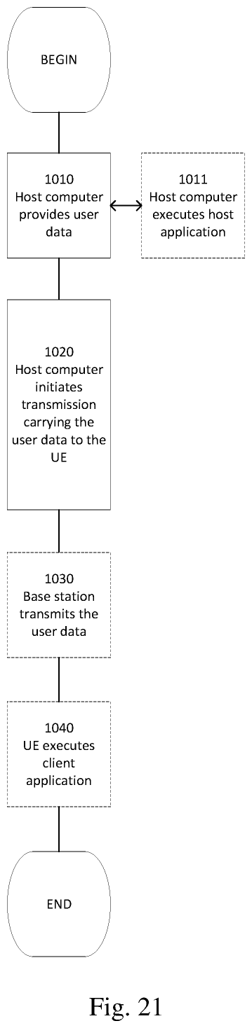

FIG. 20 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 20. In a communication system 900, a host computer 910 comprises hardware 915 including a communication interface 916 configured to set up and maintain a wired or wireless connection with an interface of a different communication device of the communication system 900. The host computer 910 further comprises a processing circuitry 918, which may have storage and/or processing capabilities. In particular, the processing circuitry 918 may comprise one or more programmable processors, application-specific integrated circuits, field programmable gate arrays or combinations of these (not shown) adapted to execute instructions. The host computer 910 further comprises software 911, which is stored in or accessible by the host computer 910 and executable by the processing circuitry 918. The software 911 includes a host application 912. The host application 912 may be operable to provide a service to a remote user, such as UE 930 connecting via an OTT connection 950 terminating at the UE 930 and the host computer 910. In providing the service to the remote user, the host application 912 may provide user data which is transmitted using the OTT connection 950.

The communication system 900 further includes a base station 920 provided in a telecommunication system and comprising hardware 925 enabling it to communicate with the host computer 910 and with the UE 930. The hardware 925 may include a communication interface 926 for setting up and maintaining a wired or wireless connection with an interface of a different communication device of the communication system 900, as well as a radio interface 927 for setting up and maintaining at least a wireless connection 970 with the UE 930 located in a coverage area (not shown in FIG. 20) served by the base station 920. The communication interface 926 may be configured to facilitate a connection 960 to the host computer 910. The connection 960 may be direct or it may pass through a core network (not shown in FIG. 20) of the telecommunication system and/or through one or more intermediate networks outside the telecommunication system. In the embodiment shown, the hardware 925 of the base station 920 further includes a processing circuitry 928, which may comprise one or more programmable processors, application-specific integrated circuits, field programmable gate arrays or combinations of these (not shown) adapted to execute instructions. The base station 920 further has software 921 stored internally or accessible via an external connection.

The communication system 900 further includes the UE 930 already referred to. Its hardware 935 may include a radio interface 937 configured to set up and maintain a wireless connection 970 with a base station serving a coverage area in which the UE 930 is currently located. The hardware 935 of the UE 930 further includes a processing circuitry 938, which may comprise one or more programmable processors, application-specific integrated circuits, field programmable gate arrays or combinations of these (not shown) adapted to execute instructions. The UE 930 further comprises software 931, which is stored in or accessible by the UE 930 and executable by the processing circuitry 938. The software 931 includes a client application 932. The client application 932 may be operable to provide a service to a human or non-human user via the UE 930, with the support of the host computer 910. In the host computer 910, an executing host application 912 may communicate with the executing client application 932 via the OTT connection 950 terminating at the UE 930 and the host computer 910. In providing the service to the user, the client application 932 may receive request data from the host application 912 and provide user data in response to the request data. The OTT connection 950 may transfer both the request data and the user data. The client application 932 may interact with the user to generate the user data that it provides.

It is noted that the host computer 910, the base station 920 and the UE 930 illustrated in FIG. 20 may be similar or identical to the host computer 830, one of base stations 812a, 812b, 812c and one of UEs 891, 892 of FIG. 19, respectively. This is to say, the inner workings of these entities may be as shown in FIG. 20 and independently, the surrounding network topology may be that of FIG. 19.

In FIG. 20, the OTT connection 950 has been drawn abstractly to illustrate the communication between the host computer 910 and the UE 930 via the base station 920, without explicit reference to any intermediary devices and the precise routing of messages via these devices. Network infrastructure may determine the routing, which it may be configured to hide from the UE 930 or from the service provider operating the host computer 910, or both. While the OTT connection 950 is active, the network infrastructure may further take decisions by which it dynamically changes the routing (e.g., on the basis of load balancing consideration or reconfiguration of the network).

Wireless connection 970 between the UE 930 and the base station 920 is in accordance with the teachings of the embodiments described throughout this disclosure. One or more of the various embodiments improve the performance of OTT services provided to the UE 930 using the OTT connection 950, in which the wireless connection 970 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 950 between the host computer 910 and the UE 930, in response to variations in the measurement results. The measurement procedure and/or the network functionality for reconfiguring the OTT connection 950 may be implemented in software 911 and hardware 915 of the host computer 910 or in software 931 and hardware 935 of the UE 930, or both. In embodiments, sensors (not shown) may be deployed in or in association with communication devices through which the OTT connection 950 passes; the sensors may participate in the measurement procedure by supplying values of the monitored quantities exemplified above, or supplying values of other physical quantities from which the software 911, 931 may compute or estimate the monitored quantities. The reconfiguring of the OTT connection 950 may include message format, retransmission settings, preferred routing etc.; the reconfiguring need not affect the base station 920, and it may be unknown or imperceptible to the base station 920. Such procedures and functionalities may be known and practiced in the art. In certain embodiments, measurements may involve proprietary UE signaling facilitating the host computer 910's measurements of throughput, propagation times, latency and the like. The measurements may be implemented in that the software 911 and 931 causes messages to be transmitted, in particular empty or ‘dummy’ messages, using the OTT connection 950 while it monitors propagation times, errors etc.

FIG. 21 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 21 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

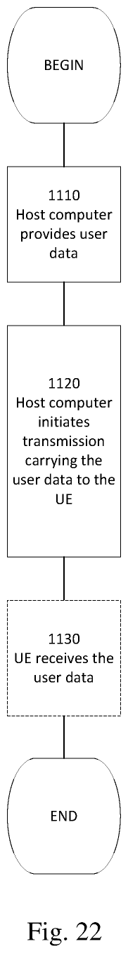

FIG. 22 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 22 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

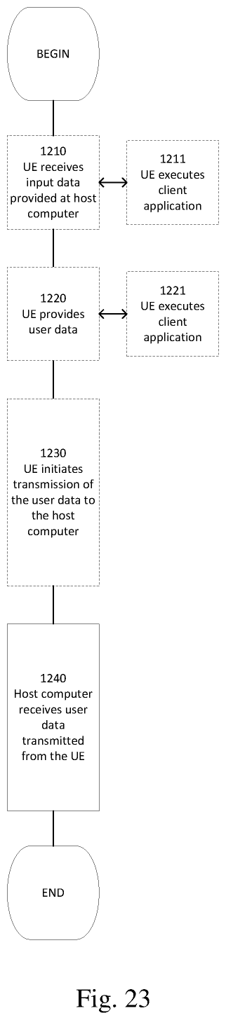

FIG. 23 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 23 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

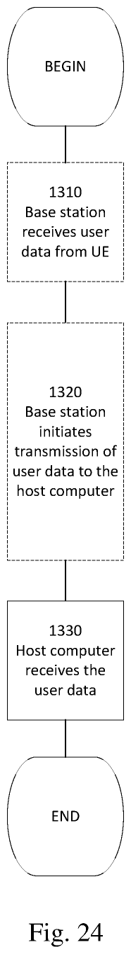

FIG. 24 is a flowchart illustrating a method implemented in a communication system, in accordance with an embodiment. The communication system includes a host computer, a base station and a UE which may be those described with reference to FIG. 19 and FIG. 20. For simplicity of the present disclosure, only drawing references to FIG. 24 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1. A method implemented at a network node in a non-terrestrial network, NTN, comprising:
determining at least a first synchronization signal (SS)/physical broadcast channel (PBCH) block, SSB, group comprising one or more SSBs and a second SSB group comprising one or more SSBs, the first SSB group being used for wide beams, and the second SSB group is used for narrow beams;
mapping a respective number of random access resources to the one or more SSBs in the first SSB group and the one or more SSBs in the second SSB group separately, the mapping comprising allocating a first number of preambles to each SSB of the first SSB group and allocating a different, second number of preambles to each SSB of the second SSB group; and
transmitting, to a terminal device in the NTN, configuration information indicating the mapping of the respective number of random access resources to the one or more SSBs in the first SSB group and the one or more SSBs in the second SSB group.

2. (canceled)

3. (canceled)

4. The method according to claim 1, wherein mapping a respective number of random access resources to the one or more SSBs in the first SSB group and the one or more SSBs in the second SSB group separately comprises:
mapping a first set of RACH occasions to the one or more SSBs in the first SSB group; and
mapping a second set of RACH occasions to the one or more SSBs in the second SSB group.

5. The method according to claim 4, wherein the number of RACH occasions in the first set is different from the number of RACH occasions in the second set.

6. The method according to claim 1, wherein mapping a respective number of random access resources to the one or more SSBs in the first SSB group and the one or more SSBs in the second SSB group separately comprises:
configuring a first SSB to random access channel, RACH, occasion mapping for the first SSB group; and
configuring a second SSB to RACH occasion mapping for the second SSB group.

7. The method according to claim 1, wherein;
one or both of:
the first and second numbers of preambles and
the number of RACH occasions in the first and second set,
are different depending on one or both of:
at least one of sizes of beams for which the first SSB group and the second SSB group are used; and
a beam deployment in a coverage of the network node.

8. The method according to claim 1, further comprising:
configuring a dedicated SSB resource list for one of the first and second SSB groups for a contention-free random access procedure, wherein the SSB resource in the dedicated SSB resource list indicates one or more SSB indices and one or more preamble identifiers; and
wherein the configuration information further indicates the dedicated SSB resource list.

9. The method according to claim 1, further comprising:
configuring a dedicated SSB to RACH occasion mapping for one of the first and second SSB groups for a contention-free random access procedure; and
wherein the configuration information further indicates the dedicated SSB to RACH occasion mapping.

10. The method according to claim 1, further comprising:
determining, for a two-step random access procedure, a first mapping ratio between a Physical Random Access Channel, PRACH, resource and a Physical Uplink Shared Channel, PUSCH, resource for the first SSB group; and
determining a second mapping ratio between the PRACH resource and the PUSCH resource for the second SSB group; and
wherein one or both:
the configuration information further indicates the first mapping ratio and the second mapping ratio; and
the first mapping ratio is different from the second mapping ratio.

11. (canceled)

12. (canceled)

13. The method according to claim 1, wherein when the wide beam is used to cover an area that has a larger amount of expected terminal devices than the narrow beam, at least one of the following:
1) the first number of preambles is larger than the second number of preambles;
2) the number of RACH occasions in the first set is larger than the number of RACH occasions in the second set; and
3) the first mapping ratio is larger than the second mapping ratio.

14. The method according to claim 1, wherein when the wide beam is used to cover an area that has a smaller amount of expected terminal devices than the narrow beam, at least one of the following:
1) the first number of preambles is smaller than the second number of preambles;
2) the number of RACH occasions in the first set is smaller than the number of RACH occasions in the second set; and
3) the first mapping ratio is smaller than the second mapping ratio.

15. The method according to claim 1, further comprising:
receiving a preamble on a RACH occasion from a terminal device; and
determining an SSB that was used by the terminal device, based on the received preamble and the RACH occasion.

16. A network node in a non-terrestrial network, NTN, comprising:
one or more processors; and
one or more memories comprising computer program code,
the one or more memories and the computer program code configured to, with the one or more processors, cause the network node to:
determine at least a first synchronization signal (SS)/physical broadcast channel (PBCH) block, SSB, group comprising one or more SSBs and a second SSB group comprising one or more SSBs, the first SSB group being used for wide beams, and the second SSB group being used for narrow beams;
map a respective number of random access resources to the one or more SSBs in the first SSB group and the one or more SSBs in the second SSB group separately, the mapping comprising allocating a first number of preambles to each SSB of the first SSB group and allocating a different, second number of preambles to each SSB of the second SSB group; and
transmit configuration information indicating the mapping of the respective number of random access resources to the one or more SSBs in the first SSB group and the one or more SSBs in the second SSB group.

17. (canceled)

18. (canceled)

19. A method implemented at a terminal device in a non-terrestrial network, NTN, comprising:
receiving configuration information indicating a mapping of a respective number of random access resources to one or more SSBs in a first SSB group and one or more SSBs in a second SSB group, the mapping comprising a first number of preambles allocated to each SSB of the first SSB group and a different, second number of preambles allocated to each SSB of the second SSB group;
selecting the SSB of the first SSB group or the second SSB group, the first SSB group being used for wide beams, and the second SSB group being used for narrow beams; and
performing a random access procedure using the random access resource mapped to the selected SSB.

20. (canceled)

21. (canceled)

22. The method according to claim 19, wherein one of more of:
the mapping comprises:
a first set of RACH occasions being mapped to the one or more SSBs in the first SSB group; and
a second set of RACH occasions being mapped to the one or more SSBs in the second SSB group;
the number of RACH occasions in the first set is different from the number of RACH occasions in the second set;
the mapping comprises:
a first SSB to random access channel, RACH, occasion mapping being configured for the first SSB group; and
a second SSB to RACH occasion mapping being configured for the second SSB group;
the configuration information further indicates a dedicated SSB resource list for one of the first and second SSB groups for a contention-free random access procedure, wherein the SSB resource in the dedicated SSB resource list indicates one or more SSB indices and one or more preamble identifiers;
the configuration information further indicates a dedicated SSB to RACH occasion mapping for one of the first and second SSB groups for a contention-free random access procedure;
the configuration information further indicates, for a two-step random access procedure, a first mapping ratio between a Physical Random Access Channel, PRACH, resource and a Physical Uplink Shared Channel, PUSCH, resource for the first SSB group, and a second mapping ratio between the PRACH resource and the PUSCH resource for the second SSB group; and
the first mapping ratio is different from the second mapping ratio.

23.-27. (canceled)

28. The method according to claim 22, wherein the first mapping ratio is different from the second mapping ratio.

29. The method according to claim 19, wherein the first SSB group is used for wide beams, and the second SSB group is used for narrow beams.

30. The method according to claim 29, wherein one or both:
when the wide beam is used to cover an area that has a larger amount of expected terminal devices than the narrow beam, at least one of the following:
1) the first number of preambles is larger than the second number of preambles;
2) the number of RACH occasions in the first set is larger than the number of RACH occasions in the second set; and
3) the first mapping ratio is larger than the second mapping ratio; and
when the wide beam is used to cover an area that has a smaller amount of expected terminal devices than the narrow beam, at least one of the following:
1) the first number of preambles is smaller than the second number of preambles;
2) the number of RACH occasions in the first set is smaller than the number of RACH occasions in the second set; and
3) the first mapping ratio is smaller than the second mapping ratio.

31. (canceled)

32. A terminal device in a non-terrestrial network, NTN, comprising:
one or more processors; and
one or more memories comprising computer program code, the one or more memories and the computer program code configured to, with the one or more processors, cause the terminal device to:
receive configuration information indicating a mapping of a respective number of random access resources to one or more SSBs in a first SSB group and one or more SSBs in a second SSB group, the mapping comprising a first number of preambles allocated to each SSB of the first SSB group and a different, second number of preambles allocated to each SSB of the second SSB group;
select the SSB of the first SSB group or the second SSB group, the first SSB group being used for wide beams, and the second SSB group being used for narrow beams; and
perform a random access procedure using the random access resource mapped to the selected SSB.

33. (canceled)

34. (canceled)
